(19) United States
(12) Patent Application Publication
(10) Pub. No.: US 2025/0222926 A1
(43) Pub. Date: Jul. 10, 2025

(54) DRIVER INTERACTIVE SYSTEM AND METHOD FOR ADAPTIVE CRUISE CONTROL AUTO RE-ENGAGEMENT

(71) Applicant: GM GLOBAL TECHNOLOGY OPERATIONS LLC, Detroit, MI (US)

(72) Inventors: Ashraf Abualfellat, Grand Blanc, MI (US); Kevin A. O'Dea, Ann Arbor, MI (US); Mohammadali Shahriari, Markham (CA); Zachary Lott, Rochester Hills, MI (US)

(73) Assignee: GM GLOBAL TECHNOLOGY OPERATIONS LLC, Detroit, MI (US)

(21) Appl. No.: 18/406,340

(22) Filed: Jan. 8, 2024

(51) Int. Cl. B60W 30/14; B60W 30/165; B60W 30/18; B60W 40/02; B60W 40/08; B60W 50/00; B60W 50/10; B60W 50/14

(52) U.S. Cl. CPC B60W 30/143; B60W 30/165; B60W 30/18027; B60W 30/18154; B60W 40/02; B60W 40/08; B60W 50/10; B60W 50/14; B60W 2050/0083; B60W 2520/10; B60W 2540/12; B60W 2554/802; B60W 2555/20

(57) ABSTRACT

A system and method of adaptive cruise control (ACC) for a vehicle equipped with ACC includes providing a controller in communication with the vehicle equipped with ACC, the controller configured to receive input from a driver and a plurality of vehicle sensors; engaging the ACC at a desired set speed, wherein the ACC is engaged via the controller in response to a first driver input and/or a first sensor input from the plurality of vehicle sensors; receiving, via the controller, a second driver input; disengaging the ACC, via the controller, in response to receiving the second driver input and/or a second sensor input from the plurality of vehicle sensors; and re-engaging the ACC at the desired set speed, wherein the ACC is re-engaged via the controller automatically.

### INTRODUCTION

The present disclosure relates to a system and method of adaptive cruise control (ACC) and, more particularly, to a system and method of ACC including a driver interactive auto re-engagement strategy, and a driver interactive set speed learning strategy.

ACC is a driver-assistance system for a vehicle that automatically adjusts a vehicle set speed to maintain a set following distance between a vehicle equipped with ACC and a vehicle ahead of the vehicle equipped with ACC. The vehicle set speed and the set following distance are initially set by a driver. ACC systems use a combination of sensors and radar, lidar, laser, camera(s), and the like to detect an actual distance between the vehicle equipped with ACC and the vehicle ahead of the vehicle equipped with ACC, and maintain the actual distance at the set following distance by activating a braking system when the actual distance decreases below the set following distance, and a vehicle acceleration system when the actual distance increases above the set following distance.

The set speed is adjusted manually by a driver and/or intelligently based on an input from another vehicle system, e.g., a road speed limit input received from a navigation system.

### SUMMARY

The adaptive cruise control (ACC) system and method disclosed herein includes a driver interactive auto re-engagement strategy that may enable the ACC system to learn the driver's desired set speed by continuously monitoring driver inputs, systematically disabling the ACC, learning the drivers new desired input by monitoring a speed profile using a driver interactive set speed learning feature, and automatically adapting the set speed to meet the driver's intent.

A method of adaptive cruise control (ACC) for a vehicle in accordance with the present disclosure may include providing a controller in communication with the vehicle equipped with ACC, which may be configured to receive driver input from a driver and sensor input from a plurality of vehicle sensors; engaging the ACC at a desired set speed, such that the ACC is engaged via the controller in response to a first driver input and/or a first sensor input from the plurality of vehicle sensors; receiving, via the controller, a second driver input and/or a second sensor input from the plurality of vehicle sensors; disengaging the ACC, via the controller, in response to receiving the second driver input and/or the second sensor input from the plurality of vehicle sensors; and re-engaging the ACC at the desired set speed, wherein the ACC is re-engaged via the controller automatically.

The method of ACC may further include determining whether a lead vehicle is within a predefined area of view (AoV) of the vehicle equipped with ACC; slowing the vehicle equipped with ACC when the lead vehicle is within the predefined AoV, wherein the vehicle equipped with ACC is slowed via the controller in response to the second driver input, and the second driver input includes a brake pedal apply; determining an actual following distance between the vehicle equipped with ACC and the lead vehicle; flashing an ACC tell-tale to encourage the driver to release the brake pedal apply when the actual following distance reaches a predefined following distance; waiting for the driver to release the brake pedal apply prior to re-engaging the ACC at the desired set speed; and automatically re-engaging the ACC via the controller when the brake pedal apply is released.

The method of ACC may further include determining whether a lead vehicle is within a predefined area of view (AoV) of the vehicle equipped with ACC; stopping the vehicle equipped with ACC behind the lead vehicle when the lead vehicle is within the predefined AoV, wherein the vehicle equipped with ACC is stopped via the controller in response to the second driver input, and the second driver input includes a brake pedal apply; and automatically re-engaging the ACC via the controller when the vehicle equipped with ACC is at a standstill.

The method may further include determining whether the vehicle equipped with ACC is approaching an intersection; determining whether the vehicle equipped with ACC is stopped at the intersection; and automatically re-engaging the ACC via the controller when the vehicle is at a standstill.

According to one aspect of the present disclosure, the method of ACC may further include determining whether a turn signal is active, wherein re-engaging the ACC automatically via the controller is inhibited when it is determined that the turn signal is active.

According to another aspect of the present disclosure, the method of ACC may further include determining whether a turn signal is active, wherein re-engaging the ACC automatically via the controller may include re-engaging the ACC automatically when it is determined that the turn signal is not active and the vehicle is at a standstill.

According to another aspect of the present disclosure, the method of ACC may further include evaluating alternate ACC re-engagement opportunities when it is determined that the vehicle equipped with ACC is not approaching the intersection.

According to one aspect of the present disclosure, the second driver input may include a pedal input, which may be classified as a soft pedal input that is indicative of a driver intervention, and/or a hard pedal input that is indicative of a driver override.

According to another aspect of the present disclosure, engaging the ACC at the desired set speed may further include setting the desired set speed to a new desired set speed when the pedal input is classified as the soft pedal input, wherein setting the desired set speed to the new desired set speed may include learning a new desired set speed, and learning the new desired set speed may include detecting a constant speed, when the constant speed is detected via at least one of the plurality of vehicle sensors; determining, via the controller, a steady vehicle dynamic intent at the constant speed; detecting a driver engagement level at the constant speed, wherein the driver engagement level is detected via at least another of the plurality of vehicle sensors; verifying, via the controller, at least one environmental condition at the constant speed; associating the constant speed with the steady vehicle dynamic intent, the driver engagement level, and the at least one environmental condition, such that the constant speed corresponds with the steady vehicle dynamic intent, the driver engagement level, and the at least one environmental condition at the constant speed; storing the constant speed as the new desired set speed; storing the associated steady vehicle dynamic intent, the associated driver engagement level, and the at least one associated environmental condition that correspond to the new desired set speed into the controller; and setting the desired set speed to the new desired set speed once the vehicle has maintained the new desired set speed for a predetermined period of time and when the steady vehicle dynamic intent detected, the driver engagement level detected, and the at least one environmental condition verified, each are respectively equal to the steady vehicle dynamic intent, the associated driver engagement level, and the at least one associated environmental condition that corresponds to the new desired set speed, wherein re-engaging the ACC to the desired set speed may include re-engaging the ACC at the new desired set speed via the controller automatically.

According to one aspect of the present disclosure, the pedal input may include an accelerator pedal apply and/or a brake pedal apply.

According to another aspect of the present disclosure, re-engaging the ACC via the controller automatically to the desired set speed may include re-engaging the ACC via the controller automatically to a new desired set speed when a constant speed is detected for a predetermined period of time, wherein the new desired set speed may include the constant speed.

An adaptive cruise control (ACC) system for a vehicle equipped with ACC in accordance with the present disclosure may include a controller in communication with the vehicle equipped with ACC and a plurality of vehicle sensors.

The controller may be configured to receive driver input from a driver and sensor input from the plurality of vehicle sensors; engage the ACC at a desired set speed, wherein the ACC is engaged in response to a first driver input and/or a first sensor input from the plurality of vehicle sensors; receive a second driver input and/or a second sensor input from the plurality of vehicle sensors; disengage the ACC in response to receiving the second driver input and/or the second sensor input from the plurality of vehicle sensors; and re-engage the ACC to the desired set speed, wherein the ACC is re-engaged via the controller automatically.

The controller may further be configured to determine whether a lead vehicle is within a predefined area of view of the vehicle equipped with ACC; slow the vehicle equipped with ACC, wherein the vehicle equipped with ACC is slowed via the controller in response to the second driver input, and the second driver input includes a brake pedal apply; determine an actual following distance between the vehicle equipped with ACC and the lead vehicle; flash an ACC tell-tale to encourage the driver to release the brake pedal apply when the actual following distance reaches a predefined following distance; wait for the driver to release the brake pedal apply prior to re-engaging the ACC at the desired set speed, wherein the ACC is re-engaged the ACC automatically via the controller when the brake pedal apply is released.

The controller may further be configured to determine whether a lead vehicle is within a predefined area of view of the vehicle equipped with ACC; stop the vehicle equipped with ACC behind the lead vehicle, wherein the vehicle equipped with ACC is stopped via the controller in response to the second driver input, and the second driver input includes a brake pedal apply; and wherein the ACC is re-engaged automatically via the controller when the vehicle equipped with ACC is at a standstill.

According to one aspect of the present disclosure, the controller may further be configured to set the desired set speed to a new desired set speed, wherein setting the desired set speed to the new desired set speed may include learning the new desired set speed, and learning the new desired set speed may include detecting a constant speed, wherein the constant speed is detected via at least one of the plurality of vehicle sensors; determining, via the controller, a steady vehicle dynamic intent at the constant speed; detecting a driver engagement level at the constant speed, wherein the driver engagement level is detected via at least another of the plurality of vehicle sensors; verifying, via the controller, at least one environmental condition at the constant speed; associating the constant speed with the steady vehicle dynamic intent, the driver engagement level, and the at least one environmental condition, such that the constant speed corresponds with the steady vehicle dynamic intent, the driver engagement level, and the at least one environmental condition at the constant speed; storing the constant speed as the new desired set speed; storing the associated steady vehicle dynamic intent, the associated driver engagement level, and the at least one associated environmental condition that correspond to the new desired set speed into the controller; and setting the desired set speed to the new desired set speed once the vehicle equipped with ACC has maintained the new desired set speed for a predetermined period of time and when the steady vehicle dynamic intent detected, the driver engagement level detected, and the at least one environmental condition verified each are equal respectively to the associated steady vehicle dynamic intent, the associated driver engagement level, and the at least one associated environmental condition that corresponds to the new desired set speed; and wherein re-engaging the ACC at the desired set speed may further include re-engaging the ACC at the new desired set speed, wherein the ACC is re-engaged to the new desired set speed via the controller automatically.

According to another aspect of the present disclosure, re-engaging the ACC via the controller automatically to the desired set speed may include re-engaging the ACC via the controller automatically to a new desired set speed when a constant speed is detected for a predetermined period of time, wherein the new desired set speed includes the constant speed.

A vehicle including an adaptive cruise control (ACC) system in accordance with the present disclosure may include a plurality of vehicle sensors; and a controller in communication with the vehicle equipped with ACC and the plurality of vehicle sensors.

The controller may be configured to receive driver input from a driver and sensor input from the plurality of vehicle sensors; engage the ACC at a desired set speed, wherein the ACC is engaged in response to a first driver input and/or a first sensor input from the plurality of vehicle sensors; receive a second driver input and/or a second sensor input from the plurality of vehicle sensors; disengage the ACC in response to receiving the second driver input and/or the second sensor input from the plurality of vehicle sensors; and re-engage the ACC to the desired set speed, wherein the ACC is re-engaged via the controller automatically.

According to one aspect of the present disclosure, the controller may further be configured to determine whether a lead vehicle is within a predefined area of view of the vehicle equipped with ACC; slow the vehicle equipped with ACC, wherein the vehicle equipped with ACC is slowed via the controller in response to the second driver input, and the second driver input includes a brake pedal apply; determine an actual following distance between the vehicle equipped with ACC and the lead vehicle; flash an ACC tell-tale to encourage the driver to release the brake pedal apply when the actual following distance reaches a predefined following distance; wait for the driver to release the brake pedal apply prior to re-engaging the ACC at the desired set speed, wherein the ACC is re-engaged via the controller automatically when the brake pedal apply is released.

The controller may further be configured to determine whether a lead vehicle is within a predefined area of view of the vehicle equipped with ACC; stop the vehicle equipped with ACC behind the lead vehicle, wherein the vehicle equipped with ACC is stopped via the controller in response to the second driver input, and the second driver input includes a brake pedal apply, wherein the ACC is re-engaged via the controller automatically when the vehicle equipped with ACC is at a standstill.

According to one aspect of the present disclosure, the controller may be further configured to set the desired set speed to a new desired set speed, wherein setting the desired set speed to the new desired set speed may include learning the new desired set speed and learning the new desired set speed may include detecting a constant speed; determining a steady vehicle dynamic intent at the constant speed; detecting a driver engagement level at the constant speed; verifying at least one environmental condition at the constant speed; associating the constant speed with the steady vehicle dynamic intent, the driver engagement level, and the at least one environmental condition, such that the constant speed corresponds with the steady vehicle dynamic intent, the driver engagement level, and the at least one environmental condition at the constant speed; storing the constant speed as the new desired set speed; storing the associated steady vehicle dynamic intent, the associated driver engagement level, and the at least one associated environmental condition that correspond to the new desired set speed into the controller; and setting the desired set speed to the new desired set speed once the vehicle has maintained the new desired set speed for a predetermined period of time and when the steady vehicle dynamic intent detected, the driver engagement level detected, and the at least one environmental condition verified each are equal respectively to the steady vehicle dynamic intent, the associated driver engagement level, and the at least one associated environmental condition that corresponds to the new desired set speed.

The driver interactive system and method of adaptive cruise control (ACC) auto re-engagement includes a driver interactive auto re-engagement strategy that may enable the ACC system to adjust a desired set speed, based on a driver's interaction with the vehicle and the driver's manual driving style, by learning the driver's desired set speed through continuously monitoring driver inputs, systematically disabling the ACC, learning the driver's new desired input by monitoring a speed profile using a driver interactive set speed learning feature, and adapting the set speed to meet the driver's intent.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 is a schematic illustration of a vehicle including an adaptive cruise control (ACC) system in accordance with the present disclosure.

FIG. 2 is a flow chart illustrating an auto re-engagement strategy of the ACC system shown in FIG. 1 in accordance with the present disclosure.

FIG. 3 is a flow chart illustrating a driver interactive set speed learning strategy of the ACC system shown in FIG. 1 in accordance with the present disclosure.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

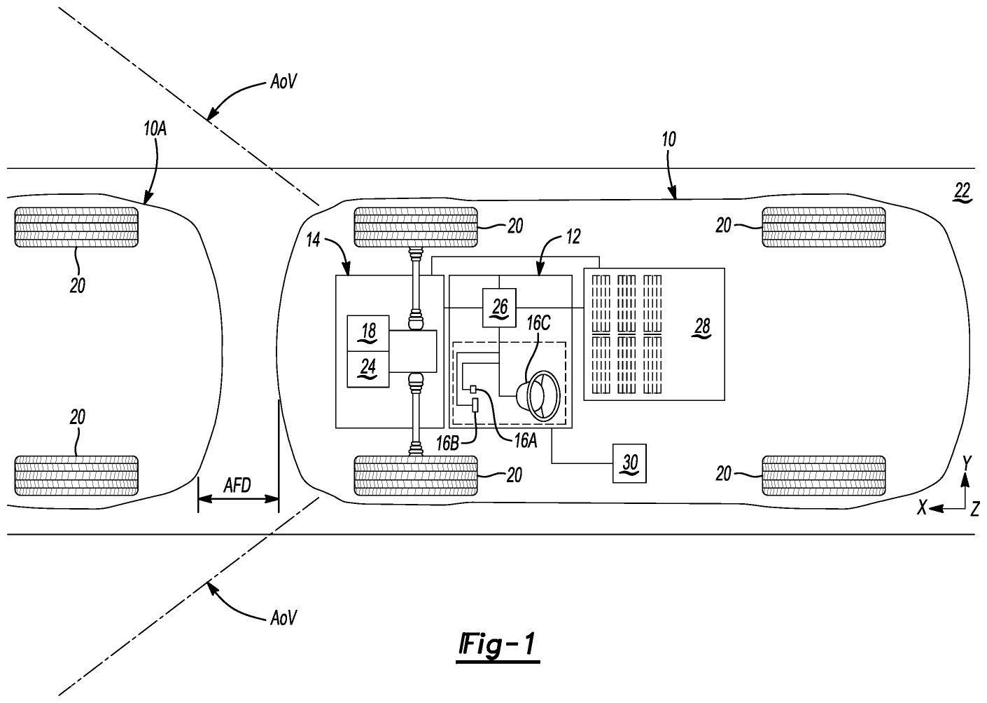

Referring to the drawings, wherein like reference numbers refer to like components, FIG. 1 schematically illustrates a vehicle 10 having an adaptive cruise control (ACC) system 12 in accordance with the present disclosure.

As illustrated in FIG. 1, a vehicle 10 equipped with ACC includes an ACC system 12, a powertrain 14, and various driver input devices 16, for example but not limited to, an accelerator pedal 16A, a brake pedal 16B, and a steering wheel 16C.

The vehicle 10 may include, but is not limited to, a commercial vehicle, an industrial vehicle, a passenger vehicle, an aircraft, a watercraft, a train or the like. It is also contemplated that the vehicle 10 may include a mobile platform, such as an airplane, an all-terrain vehicle (ATV), a boat, a personal movement apparatus, a robot and the like to accomplish the purposes of this disclosure.

The powertrain 14 includes a power-source 18 configured to generate a power-source torque T (not shown) for propulsion of the vehicle 10 via driven wheels 20 relative to a road surface 22. The power-source 18 is depicted as an internal combustion engine but may also include, for example, an electric motor-generator.

As further illustrated in FIG. 1, the powertrain 14 may also include two power-sources 18 and 24, for example, an internal combustion engine and an electric motor-generator. In which case, the power-sources 18 and 24 may act in concert to power the vehicle 10.

The vehicle 10 further includes a controller 26 and, when equipped with an electric-motor generator, a rechargeable energy storage system (RESS) 28 configured to generate and store electrical energy through heat-producing electro-chemical reactions for supplying the electrical energy to the power-sources 18 and 24. The electronic controller 26 may include a central processing unit (CPU) that regulates various functions on the vehicle 10.

In either of the above configurations, the electronic controller 26 includes a processor and tangible, non-transitory memory, which includes instructions for operation of the ACC system 12 programmed therein. The memory may be an appropriate recordable medium that participates in providing computer-readable data or process instructions. Such a recordable medium may take many forms, including, but not limited to, non-volatile media and volatile media.

Non-volatile media for the electronic controller 26 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the electronic controller 26 may also include a flexible disk, hard disk, magnetic tape, another magnetic medium, a CD-ROM, DVD, another optical medium, etc. The electronic controller 26 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 26 or accessible thereby may be stored in the memory and automatically executed to provide the required functionality of the ACC system 12, and various other vehicle systems, which may include, for example but not limited to, the powertrain 14 and the RESS 28, if so equipped.

The controller 26 is in communication with vehicle 10 equipped with ACC, a plurality of vehicle sensors schematically illustrated at 30, and various other vehicle systems, which may include but are not limited to a driver monitoring system (DMS).

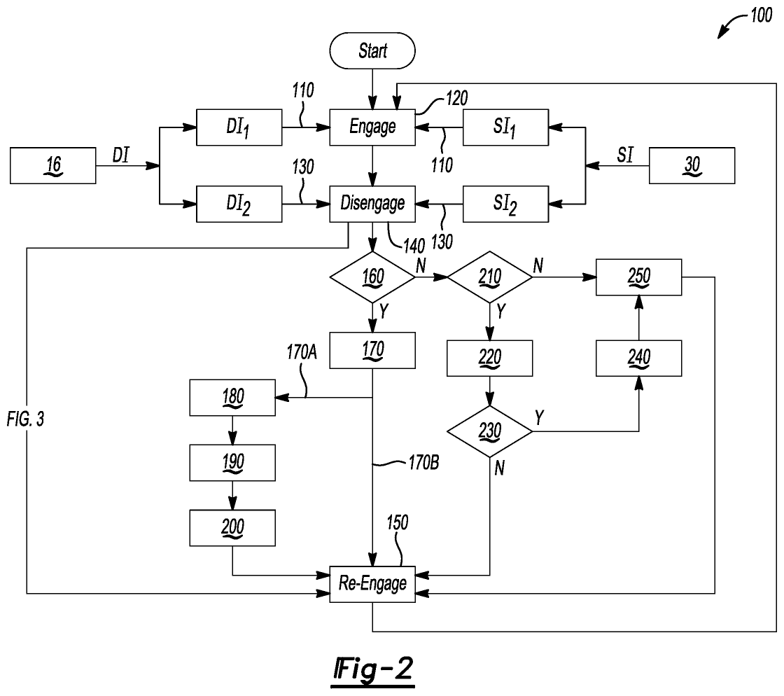

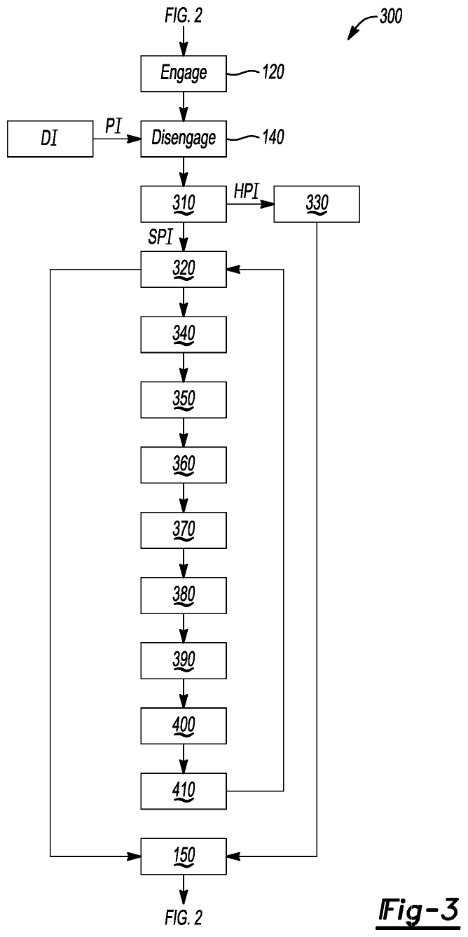

The ACC system 12 includes a driver interactive automatic re-engagement strategy, illustrated in FIG. 2, that may enable the ACC system 12 to adjust a desired set speed (DSS), based on a driver's interaction with the vehicle 10 equipped with ACC and the driver's manual driving style, by learning the driver's DSS through continuous monitoring of driver inputs (DIs), and systematic disabling of the ACC using a driver interactive set speed learning strategy, illustrated in FIG. 3, that learns the driver's new desired set speed (NDSS) by monitoring a speed profile, and adapts the DSS to meet the NDSS based on the learned driver's intent.

Referring now to FIG. 2, with continued reference to FIG. 1, a flow chart illustrating an automatic re-engagement strategy 100 in accordance with the present disclosure is shown.

The ACC system 12 includes a controller 26 in communication with a vehicle 10 equipped with ACC and a plurality of vehicle sensors 30 (FIG. 1). The automatic re-engagement strategy 100 is stored in and executed by the controller 26, which is configured to receive 110 driver input DI from a driver (not shown) via, for example, an accelerator pedal 16A, a brake pedal 16B, and/or a steering wheel 16C, and/or sensor input SI from the plurality of vehicle sensors 30, engage 120 the ACC at a desired set speed DSS in response to a first driver input DI₁ and/or a first sensor input SI₁ from at least one of the plurality of vehicle sensors 30, receive 130 a second driver input DI₂ and/or a second sensor input SI₂ from the plurality of vehicle sensors 30, disengage 140 the ACC in response to receiving the second driver input DI₂ and/or the second sensor input SI₂ from the plurality of vehicle sensors 30, and re-engage 150 the ACC at the DSS automatically.

The plurality of vehicle sensors 30 may include, for example but not limited to vehicle speed sensors, vehicle proximity sensors, steering wheel angle sensors, lateral acceleration sensors, longitudinal acceleration sensors, and the like.

According to one aspect of the present disclosure, the controller 26 is further configured to determine 160 whether a lead vehicle 10A is within a predefined area of view (AoV) of the vehicle 10 equipped with ACC, and slow and/or stop 170A/170B the vehicle 10 equipped with ACC when the lead vehicle 10A is within the predefined AoV in response to the second driver input DI₂, wherein the second driver input DI₂ includes, for example, a brake pedal 16B apply.

When the vehicle 10 equipped with ACC slows 170A behind the lead vehicle 10A in response to the second driver input DI₂, the controller 26 is further configured to determine 180 an actual following distance (AFD) between the vehicle 10 equipped with ACC and the lead vehicle 10A; flash 190 an ACC tell-tale to encourage the driver to release the brake pedal 16B apply when the AFD reaches a predefined following distance (PFD); wait 200 for the driver to release the brake pedal 16B apply prior to re-engaging the ACC at the DSS; and re-engage 150 the ACC automatically when the brake pedal 16B apply is released.

When the vehicle 10 equipped with ACC stops 170B behind the lead vehicle 10A in response to the second driver input DI₂, wherein the second driver input DI₂ includes, for example, a brake pedal 16B apply, the controller 26 is further configured to re-engage 150 the ACC automatically when the vehicle 10 equipped with ACC is at a standstill.

According to another aspect of the present disclosure, the controller 26 is further configured to determine 210 whether the vehicle 10 equipped with ACC is approaching an intersection, determine 220 whether the vehicle equipped with ACC is stopped at the intersection, and re-engage 150 the ACC automatically when the vehicle is at a standstill.

When it is determined that the vehicle 10 equipped with ACC is approaching the intersection and the vehicle 10 equipped with ACC is stopped at the intersection, the controller may further be configured to determine 230 whether a turn-signal is active, and re-engage 150 the ACC automatically when it is determined that the turn-signal is not active, or inhibit 240 re-engaging the ACC automatically when the turn-signal is active.

When it is determined that the vehicle 10 equipped with ACC is not approaching an intersection, the controller 26 is further configured to evaluate 250 alternate re-engagement opportunities, for example but not limited to, when a fault is cleared, e.g., when one or more of the plurality of vehicle sensors, blocked by ice and/or snow is cleared, upon sensing that the vehicle 10 equipped with ACC is slowing for an exit ramp and/or merging onto a new road or highway, and the like, and re-engage 150 the ACC automatically when the vehicle is at a standstill.

Referring now to FIG. 3, with continued reference to FIGS. 1 and 2, a flow chart illustrating a driver interactive set speed learning strategy 300 in accordance with the present disclosure is shown.

An ACC system 12 includes a controller 26 in communication with a vehicle 10 and a plurality of vehicle sensors 30 (FIG. 1). The driver interactive set speed learning strategy 300 is stored in and executed by the controller 26, which is configured to receive 110 driver input DI from a driver (not shown) via, for example, an accelerator pedal 16A, a brake pedal 16B, and/or a steering wheel 16C, and/or sensor input SI from the plurality of vehicle sensors 30 (FIG. 1).

The second driver input DI₂, includes a pedal input PI from, for example the accelerator pedal 16A and/or the brake pedal 16B, and the controller 26 is configured to classify 310 the PI as a soft pedal input SPI that is indicative of a driver intervention, or a hard pedal input HPI that is indicative of a driver override. The pedal input PI may include, for example, an accelerator pedal 16A apply and/or a brake pedal 16B apply.

The driver interactive set speed learning strategy 300 includes setting 320 the desired set speed (DSS), to which the ACC was engaged at 120 (FIG. 2), to a new desired set speed (NDSS) when the pedal input PI is classified as the soft pedal input SPI, which is indicative of the driver intervention.

Setting 320 the DSS includes learning 340 the NDSS, which includes detecting 350 a constant speed CS of the vehicle 10 equipped with ACC, wherein the SS is detected via at least one of the plurality of vehicle sensors 30; determining 360 a steady vehicle dynamic intent (SVDI) at the SS; detecting 370 a driver engagement level (DEL) at the SS, wherein the DEL is detected via, for example, at least another of the plurality of vehicle sensors 30, or another vehicle system including but not limited to, for example, a Driver Monitoring System (DMS); verifying 380 at least one environmental condition (EC), for example but not limited to a speed SPD of the vehicle 10 equipped with ACC; associating 390 the SS with the SVDI, the DEL, the at least one EC, such that the SS corresponds with the SVDI, the DEL and the at least one EC at the SS; storing 400 the SS detected at 350 as the NDSS; storing 410 the associated SVDI, the associated DEL, and the at least one associated EC that correspond to the NDSS into the controller 26; and setting 320 the DSS to the NDSS once the vehicle 10 equipped with ACC has maintained the NDSS for a predetermined period of time T_{PD} and when the detected SVDI, the detected DEL, and the at least one verified EC, each are respectively equal to the SVDI, the associated DEL, and the at least one associated EC that corresponds to the NDSS, wherein re-engaging 150 the ACC at the DSS further includes re-engaging the ACC automatically at the NDSS.

The SS is detected using sensor input SI from the plurality of vehicle sensors 30 based upon the formula (1) below:

DR>K_{DR} AND |Ay|<K_{AY} AND SPD>K_{SPD} AND |Ax|<K_{AX} for T_{PD}. (1)

Where DR is a distance ratio of a desired distance DD between the vehicle 10 equipped with ACC and a lead vehicle 10A and the actual distance DA between the vehicle 10 equipped with ACC and the lead vehicle 10A, K_{DR} is a calibration value related to the distance ratio DR, Ay is a lateral acceleration of the vehicle 10 equipped with ACC, K_{AY} is a calibration value related to the lateral acceleration Ay, Ax is a longitudinal acceleration of the vehicle 10 equipped with ACC, K_{AX} is a calibration value related to the longitudinal acceleration Ax, SPD is a speed of the vehicle 10 equipped with ACC, and K_{SPD} is a calibration value related to the speed of the vehicle 10 equipped with ACC over a predetermined period of time T_{PD}.

The SVDI is determined based upon the formula (2) below:

SWA Rate <|K_{SWA}|. (2)

Where SWA Rate is a steering wheel angle rate, which may be detected by at least one of the plurality of vehicle sensors 30, and K_{SWA} is a calibration value related to the steering wheel angle rate SWA.

One or more of the calibration values K_{DR}, K_{AY}, K_{AX}, K_{SPD}, and K_{SWA}, may include a fixed value stored in the controller 26, or a variable value related to one or more of the vehicle parameters DR, Ay, Ax, SPD, and SWA, stored in one or more tables accessible by the controller 26.

According to another aspect of the present disclosure, re-engaging the ACC via the controller 26 automatically at the DSS includes re-engaging the ACC via the controller 26 automatically at the NDSS when the ACC system 12 detects a constant speed (Sc) for a predetermined period of time (T_{PD}), wherein the NDSS includes the Sc.

When the pedal input PT is classified 330 as the hard pedal input HPI, which is indicative of the driver override, the driver interactive set speed learning strategy 300 includes re-engaging 150 the DSS automatically.

The illustrated aspects of the disclosure of the adaptive cruise control (ACC) system and method disclosed herein includes a driver interactive auto re-engagement strategy that enables the ACC system to learn the driver's desired set speed by continuously monitoring driver inputs, systematically disabling the ACC, learning the drivers new desired input by monitoring a speed profile using a driver interactive set speed learning feature, and automatically adapting the set speed to meet the driver's intent.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method of adaptive cruise control (ACC) for a vehicle equipped with ACC, the method comprising:
providing a controller in communication with the vehicle equipped with ACC, the controller configured to receive driver input from a driver and sensor input from a plurality of vehicle sensors;
engaging the ACC at a desired set speed, wherein the ACC is engaged via the controller in response to a first driver input and/or a first sensor input from the plurality of vehicle sensors;
receiving, via the controller, a second driver input and/or a second sensor input from the plurality of vehicle sensors;
disengaging the ACC, via the controller, in response to receiving the second driver input and/or a second sensor input from the plurality of vehicle sensors; and
re-engaging the ACC at the desired set speed, wherein the ACC is re-engaged via the controller automatically.

2. The method of ACC as recited in claim 1, further including:
determining whether a lead vehicle is within a predefined area of view of the vehicle equipped with ACC;
slowing the vehicle equipped with ACC when the lead vehicle is within the predefined AoV, wherein the vehicle equipped with ACC is slowed via the controller in response to the second driver input, and the second driver input includes a brake pedal apply;
determining an actual following distance between the vehicle equipped with ACC and the lead vehicle;
flashing an ACC tell-tale to encourage the driver to release the brake pedal apply when the actual following distance reaches a predefined following distance; and
waiting for the driver to release the brake pedal apply prior to re-engaging the ACC at the desired set speed; and
wherein the ACC is re-engaged via the controller automatically when the brake pedal apply is released.

3. The method of ACC as recited in claim 1, further including:
determining whether a lead vehicle is within a predefined area of view of the vehicle equipped with ACC; and
stopping the vehicle equipped with ACC behind the lead vehicle when the lead vehicle is within the predefined AoV, wherein the vehicle equipped with ACC is stopped via the controller in response to the second driver input, and the second driver input includes a brake pedal apply; and
wherein the ACC is re-engaged via the controller automatically when the vehicle equipped with ACC is at a standstill.

4. The method of ACC as recited in claim 1, further including:
determining whether the vehicle equipped with ACC is approaching an intersection; and
determining whether the vehicle equipped with ACC is stopped at the intersection; and
wherein the ACC is re-engaged via the controller automatically when the vehicle is at a standstill.

5. The method of ACC as recited in claim 4, further including determining whether a turn signal is active; and
wherein re-engaging the ACC via the controller automatically is inhibited when it is determined that the turn signal is active.

6. The method of ACC as recited in claim 4, further including determining whether a turn signal is active; and
wherein re-engaging the ACC via the controller automatically includes re-engaging the ACC when it is determined that the turn signal is not active and the vehicle is at a standstill.

7. The method of ACC as recited in claim 4, further including evaluating alternate ACC re-engagement opportunities when it is determined that the vehicle equipped with ACC is not approaching the intersection.

8. The method of ACC as recited in claim 1, wherein the second driver input includes a pedal input, wherein the pedal input is classified as a soft pedal input that is indicative of a driver intervention, or a hard pedal input that is indicative of a driver override.

9. The method of ACC as recited in claim 8, wherein engaging the ACC at the desired set speed further includes setting the desired set speed to a new desired set speed when the pedal input is classified as the soft pedal input, wherein setting the desired set speed to the new desired set speed includes:
learning a new desired set speed, wherein learning the new desired set speed includes:
detecting a constant speed, wherein the constant speed is detected via at least one of the plurality of vehicle sensors;
determining, via the controller, a steady vehicle dynamic intent at the constant speed;
detecting a driver engagement level at the constant speed, wherein the driver engagement level is detected via at least another of the plurality of vehicle sensors;
verifying, via the controller, at least one environmental condition at the constant speed;
associating the constant speed with the steady vehicle dynamic intent, the driver engagement level, and the at least one environmental condition, such that the constant speed corresponds with the steady vehicle dynamic intent, the driver engagement level, and the at least one environmental condition at the constant speed;
storing the constant speed as the new desired set speed;
storing the associated steady vehicle dynamic intent, the associated driver engagement level, and the at least one associated environmental condition that correspond to the new desired set speed into the controller; and
setting the desired set speed to the new desired set speed once the vehicle has maintained the new desired set speed for a predetermined period of time and when the steady vehicle dynamic intent detected, the driver engagement level detected, and the at least one environmental condition verified, each are respectively equal to the steady vehicle dynamic intent, the associated driver engagement level, and the at least one associated environmental condition that corresponds to the new desired set speed; and
wherein re-engaging the ACC at the desired set speed further includes re-engaging the ACC at the new desired set speed, wherein the ACC is re-engaged to the new desired set speed via the controller automatically.

10. The method of ACC as recited in claim 9, wherein the pedal input includes an accelerator pedal apply and/or a brake pedal apply.

11. The method of ACC as recited in claim 1, wherein re-engaging the ACC via the controller automatically to the desired set speed includes re-engaging the ACC via the controller automatically to a new desired set speed when a constant speed is detected for a predetermined period of time, wherein the new desired set speed includes the constant speed.

12. An adaptive cruise control (ACC) system for a vehicle equipped with ACC, the ACC system comprising:
a controller in communication with the vehicle equipped with ACC and a plurality of vehicle sensors, the controller configured to:
receive driver input from a driver and sensor input from the plurality of vehicle sensors;
engage the ACC system at a desired set speed, wherein the ACC is engaged in response to a first driver input and/or a first sensor input from the plurality of vehicle sensors;
receive a second driver input and/or a second sensor input from the plurality of vehicle sensors;
disengage the ACC system in response to receiving the second driver input and/or the second sensor input from the plurality of vehicle sensors; and
re-engage the ACC system to the desired set speed, wherein the ACC is re-engaged via the controller automatically.

13. The ACC system as recited in claim 12, wherein the controller is further configured to:
determine whether a lead vehicle is within a predefined area of view of the vehicle equipped with ACC;
slow the vehicle equipped with ACC, wherein the vehicle equipped with ACC is slowed via the controller in response to the second driver input, and the second driver input includes a brake pedal apply;
determine an actual following distance between the vehicle equipped with ACC and the lead vehicle;
flash an ACC tell-tale to encourage the driver to release the brake pedal apply when the actual following distance reaches a predefined following distance; and
wait for the driver to release the brake pedal apply prior to re-engaging the ACC at the desired set speed; and
wherein the ACC is re-engaged via the controller automatically when the brake pedal apply is released.

14. The ACC system as recited in claim 12, wherein the controller is further configured to:
determine whether a lead vehicle is within a predefined area of view of the vehicle equipped with ACC; and
stop the vehicle equipped with ACC behind the lead vehicle, wherein the vehicle equipped with ACC is stopped via the controller in response to the second driver input, and the second driver input includes a brake pedal apply; and
wherein the ACC is re-engaged via the controller automatically when the vehicle equipped with ACC is at a standstill.

15. The ACC system as recited in claim 12, wherein the controller is further configured to set the desired set speed to a new desired set speed, wherein setting the desired set speed to the new desired set speed includes:
learning the new desired set speed, wherein learning the new desired set speed includes:
detecting a constant speed, wherein the constant speed is detected via at least one of the plurality of vehicle sensors;
determining, via the controller, a steady vehicle dynamic intent at the constant speed;
detecting a driver engagement level at the constant speed, wherein the driver engagement level is detected via at least another of the plurality of vehicle sensors;
verifying, via the controller, at least one environmental condition at the constant speed; and
associating the constant speed with the steady vehicle dynamic intent, the driver engagement level, and the at least one environmental condition, such that the constant speed corresponds with the steady vehicle dynamic intent, the driver engagement level, and the at least one environmental condition at the constant speed, wherein the constant speed is the new desired set speed;
storing the constant speed as the new desired set speed;
storing the associated steady vehicle dynamic intent, the associated driver engagement level, and the at least one associated environmental condition that correspond to the new desired set speed into the controller; and
setting the desired set speed to the new desired set speed once the vehicle equipped with ACC has maintained the new desired set speed for a predetermined period of time and when the steady vehicle dynamic intent detected, the driver engagement level detected, and the at least one environmental condition verified, each are respectively equal to the associated steady vehicle dynamic intent, the associated driver engagement level, and the at least one associated environmental condition that corresponds to the new desired set speed; and
wherein re-engaging the ACC at the desired set speed further includes re-engaging the ACC at the new desired set speed, wherein the ACC is re-engaged to the new desired set speed via the controller automatically.

16. The ACC system as recited in claim 12, wherein re-engaging the ACC via the controller automatically to the desired set speed includes re-engaging the ACC via the controller automatically to a new desired set speed when the ACC system detects a constant speed for a predetermined period of time, wherein the new desired set speed includes the constant speed.

17. A vehicle including an adaptive cruise control (ACC) system, the vehicle comprising:
a plurality of vehicle sensors; and
a controller in communication with the vehicle equipped with ACC and the plurality of vehicle sensors, the controller configured to:
receive driver input from a driver and sensor input from the plurality of vehicle sensors;
engage the ACC system at a desired set speed, wherein the ACC is engaged in response to a first driver input and/or a first sensor input from the plurality of vehicle sensors;
receive a second driver input and/or a second sensor input from the plurality of vehicle sensors;
disengage the ACC system in response to receiving the second driver input and/or the second sensor input from the plurality of vehicle sensors; and
re-engage the ACC system to the desired set speed, wherein the ACC is re-engaged via the controller automatically.

18. The vehicle as recited in claim 17, wherein the controller is further configured to:
determine whether a lead vehicle is within a predefined area of view of the vehicle equipped with ACC;
slow the vehicle equipped with ACC, wherein the vehicle equipped with ACC is slowed via the controller in response to the second driver input, and the second driver input includes a brake pedal apply;
determine an actual following distance between the vehicle equipped with ACC and the lead vehicle;
flash an ACC tell-tale to encourage the driver to release the brake pedal apply when the actual following distance reaches a predefined following distance; and
wait for the driver to release the brake pedal apply prior to re-engaging the ACC at the desired set speed; and
wherein the ACC is re-engaged via the controller automatically when the brake pedal apply is released.

19. The vehicle as recited in claim 17, wherein the controller is further configured to:
determine whether a lead vehicle is within a predefined area of view of the vehicle equipped with ACC; and
stop the vehicle equipped with ACC behind the lead vehicle, wherein the vehicle equipped with ACC is stopped via the controller in response to the second driver input, and the second driver input includes a brake pedal apply; and
wherein the ACC is re-engaged via the controller automatically when the vehicle equipped with ACC is at a standstill.

20. The vehicle as recited in claim 17, wherein the controller is further configured to set the desired set speed to a new desired set speed, wherein setting the desired set speed to the new desired set speed includes:
learning the new desired set speed, wherein learning the new desired set speed includes:
detecting a constant speed;
determining a steady vehicle dynamic intent at the constant speed;
detecting a driver engagement level at the constant speed;
verifying at least one environmental condition at the constant speed; and
associating the constant speed with the steady vehicle dynamic intent, the driver engagement level, and the at least one environmental condition, such that the constant speed corresponds with the steady vehicle dynamic intent, the driver engagement level, and the at least one environmental condition at the constant speed, wherein the constant speed is the new desired set speed;
storing the constant speed as the new desired set speed;
storing the associated steady vehicle dynamic intent, the associated driver engagement level, and the at least one associated environmental condition that correspond to the new desired set speed into the ACC system; and
setting the desired set speed to the new desired set speed once the vehicle has maintained the new desired set speed for a predetermined period of time and when the steady vehicle dynamic intent detected, the driver engagement level detected, and the at least one environmental condition verified each are equal respectively to the steady vehicle dynamic intent, the associated driver engagement level, and the at least one associated environmental condition that corresponds to the new desired set speed.
